(19) United States
(12) Patent Application Publication
(10) Pub. No.: US 2012/0179572 A1
(43) Pub. Date: Jul. 12, 2012

(54) Conducting Transactions Through a Publisher

(75) Inventor: Kasey Dugan Hesse, Omaha, NE (US)

(73) Assignee: eBay, Inc., San Jose, CA (US)

(21) Appl. No.: 13/338,525

(22) Filed: Dec. 28, 2011

Related U.S. Application Data
(60) Provisional application No. 61/430,843, filed on Jan. 7, 2011.

(51) Int. Cl. G06Q 30/06

(52) U.S. Cl. 705/26.8

(57) ABSTRACT

Embodiments of the present disclosure generally relate to conducting transactions through publisher content. In an embodiment, a method includes linking one or more entities with a publisher platform hosted by an electronic publication, wherein a reader downloads the electronic publication on a user device, and the one or more entities advertise one or more items on the electronic publication. The method also includes receiving, from the reader, a request to purchase selected one or more items as advertised by the one or more entities while accessing the electronic publication. The method further includes placing the selected one or more items in the publisher platform of the electronic publication that links the one or more entities. And the method also includes processing the request to purchase with a single checkout flow.

### RELATED APPLICATION

The present application claims priority to and the benefit of U.S. Provisional Patent Application No. 61/430,843 filed on Jan. 7, 2011, the contents of which are incorporated herein by reference in their entirety.

### BACKGROUND

1. Technical Field

The present disclosure generally relates to facilitating electronic commerce over a network and, more particularly, to conducting transactions through publisher content.

2. Related Art

With the expansion of digital media, print magazines are currently struggling to make themselves relevant to digital consumers. When a reader of a magazine or printed publication sees an item for possible purchase, the reader must locate more information to make the purchase. Most magazines provide shopping information (typically a store address and a phone number) in the back of the magazine in fine print. This is an impractical approach to getting consumers to a point of sale on items they wish to purchase.

Magazines recognize that they need to make the items in their pages accessible to consumers. The publishers generate income by selling advertising, and advertisers generate income from purchases. With the ever-increasing use of digital or electronic shopping, publishers utilize different ways to promote purchases through ads in printed publications. In one approach, magazines offer website addresses on an ad page, so that the reader can go to the website address to purchase the product. However, with this approach, the user still has to manually enter a URL into the user's device. In another approach, the reader takes a photo of the ad page, such as with a smart phone, and sends the photo to the publisher. The publisher then electronically sends the reader information about how to purchase products in the page.

In yet another approach, the publisher includes a code, such as a QR code, on the page, which the reader can scan or otherwise capture with a mobile device, such as a smart phone. This directs the reader to a page where the reader can make a purchase through a merchant or retailer. Even though this allows the reader to make a purchase through a mobile device, the reader may have to go through multiple pages from different retailers to make different purchases from a magazine. For example, the reader may have to go through a different checkout flow for each product, including entering payment/shipping information separately in each checkout flow. This can be cumbersome and time-consuming.

### SUMMARY

Embodiments of the present disclosure provide systems and methods where a reader of a publication may purchase items from different advertisers with a single checkout flow by linking different entities such as merchants with a publisher platform of the publication.

In accordance with an embodiment of the present disclosure, a method includes linking one or more entities with a publisher platform hosted by an electronic publication, wherein a reader downloads the electronic publication on a user device, and the one or more entities advertise one or more items on the electronic publication. The method also includes receiving, from the reader, a request to purchase selected one or more items as advertised by the one or more entities while accessing the electronic publication. The method further includes placing the selected one or more items in the publisher platform of the electronic publication that links the one or more entities. And the method also includes processing the request to purchase with a single checkout flow.

In accordance with another embodiment of the present disclosure, a system includes: a payment provider server that interacts with a user device associated with a user and one or more servers associated with one or more entities over a network; and one or more memories adapted to store a plurality of machine-readable instructions which when executed by one or more processors are adapted to cause the system to: receive, from the user, a request to purchase one or more selected items, which the user selects by selecting interfaces associated with the items while accessing digital content of a publisher downloaded onto the user device, wherein the items are offered by the one or more entities on one or more pages of the digital content; place the selected items in a cart within a platform maintained by the publisher; and process the request to purchase the selected items in the cart at any time with a single cart and payment flow.

In accordance with a further embodiment of the present disclosure, a non-transitory computer-readable medium having computer executable instructions for performing a. method includes: linking one or more entities with a platform hosted by a publisher of digital content; receiving a request for a transaction by a user accessing the digital content, wherein the request comprises the user selecting one or more desired items from the one or more entities while accessing the digital content; placing the one or more desired items in a single cart within the platform; and processing the request for the transaction at any time with the single cart on the platform and a single payment flow.

These and other aspects of the present disclosure will be more readily apparent from the detailed description of the embodiments set forth below taken in conjunction with the accompanying drawings.

### BRIEF DESCRIPTION OF THE DRAWINGS

FIG. 1A illustrates an example of digital content corresponding to a page of a publication on a user device according to an embodiment of the present disclosure.

FIG. 1B illustrates a selection view on a user device according to an embodiment of the present disclosure.

FIG. 1C illustrates another example of digital content corresponding to a page of a publication on a user device according to an embodiment of the present disclosure.

FIG. 1D illustrates yet another example of digital content corresponding to a page of a publication on a user device according to an embodiment of the present disclosure.

FIG. 1E illustrates a further example of digital content corresponding to a page of a publication on a user device according to an embodiment of the present disclosure.

FIG. 2A illustrates a screen of a user device when items have been selected for purchase and the user exits out of the publication according to an embodiment of the present disclosure.

FIG. 2B illustrates a log in screen on a user device according an embodiment of the present disclosure.

FIG. 2C illustrates a screen of a user device showing the contents of a cart according to an embodiment of the present disclosure.

FIG. 2D illustrates a screen of a user device showing confirmation of a transaction according to an embodiment of the present disclosure.

FIG. 3 is a flow diagram illustrating a method for conducting a transaction through a publisher according to an embodiment of the present disclosure.

FIG. 4 shows a block diagram of a computer system suitable for implementing one or more embodiments of the present disclosure.

Embodiments of the disclosure and their advantages are best understood by referring to the detailed description that follows.

### DETAILED DESCRIPTION

According to one or more embodiments of the present disclosure, systems and methods are provided such that a reader of digital content may easily purchase different items from different entities with a single checkout flow. According to an embodiment, a publisher of content includes active interfaces such as links within digital content, where the interfaces, when selected by the reader or user place an item associated with the interface in a cart within a publisher platform. The reader may continue to read or browse pages of the content on a user's device and select items as desired on the pages. Once the reader is finished with the content or is otherwise ready to pay for the selected items, the user may go to the cart on the publisher platform and make a payment for all the items at once.

In this disclosure, entities may refer to merchants, sellers, entity-associated websites, designers, vendors, digital media providers, business entities (profit and nonprofit), charities or any other appropriate entities. The term “items” may include products, services, charitable contributions, donations, digital content, subscriptions, etc. Also, in embodiments herein, a user or reader may conduct transactions such as purchasing products, services and/or digital content, making donations, bidding, etc. Furthermore, although one or more embodiments herein may be described with respect to items in the fashion industry, it should be understood that embodiments herein may apply to any other market segments or industries including but not limited to hobbies, furniture, gardening, electronics, news media, subscriptions, apps, or any other appropriate industries.

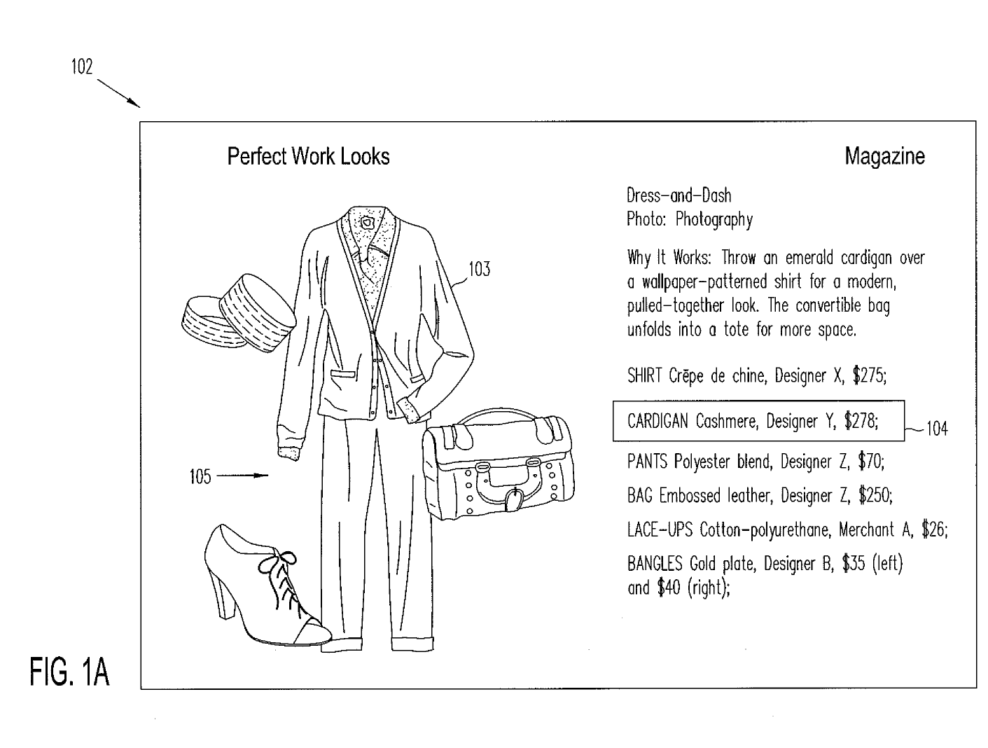

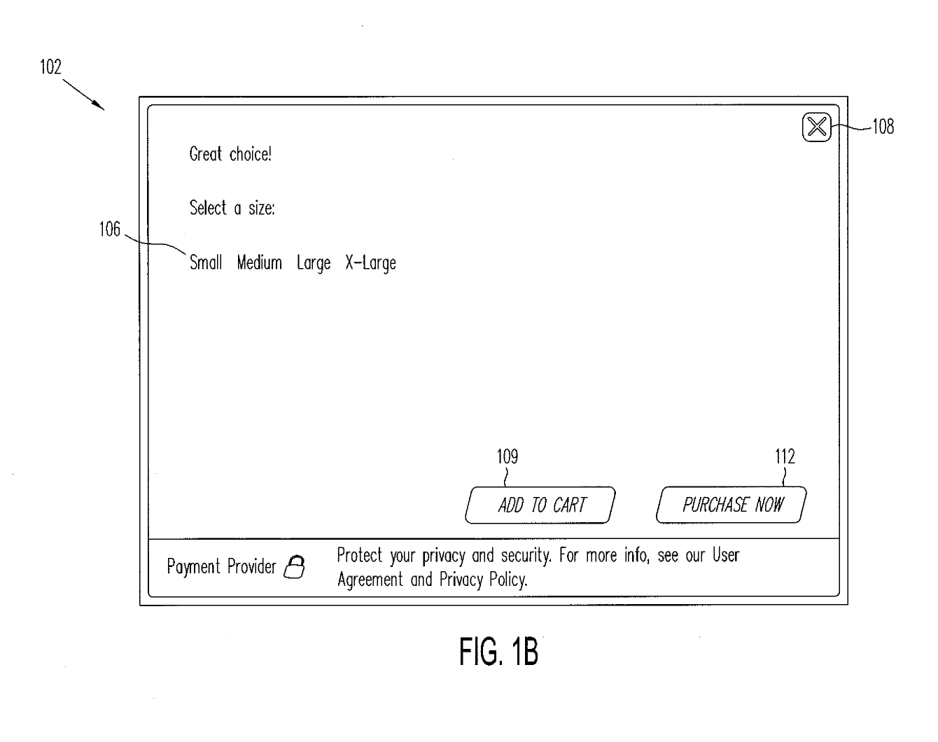

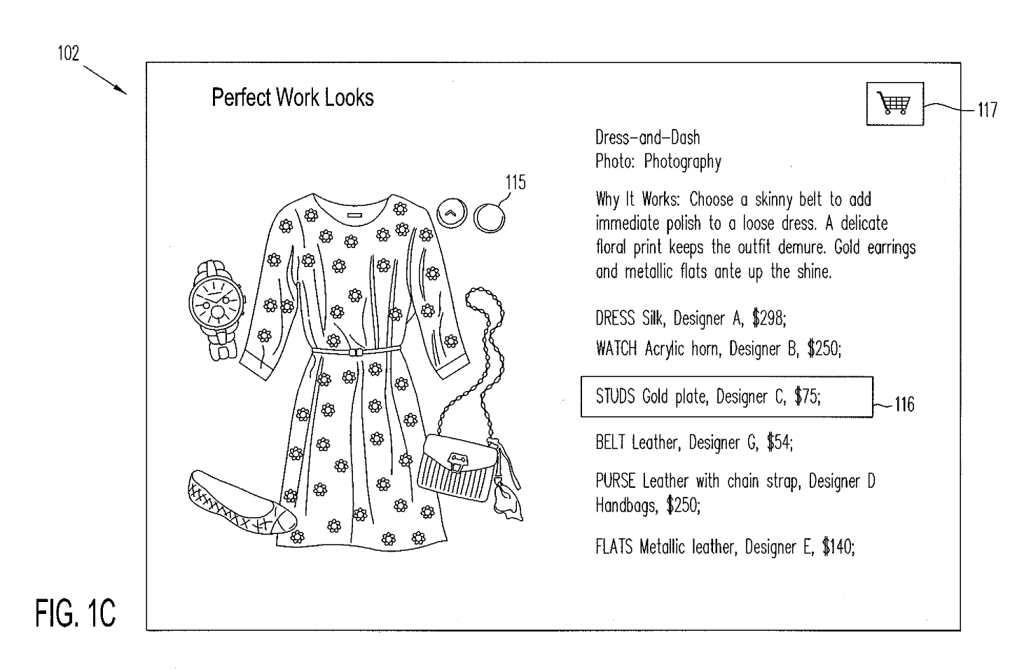

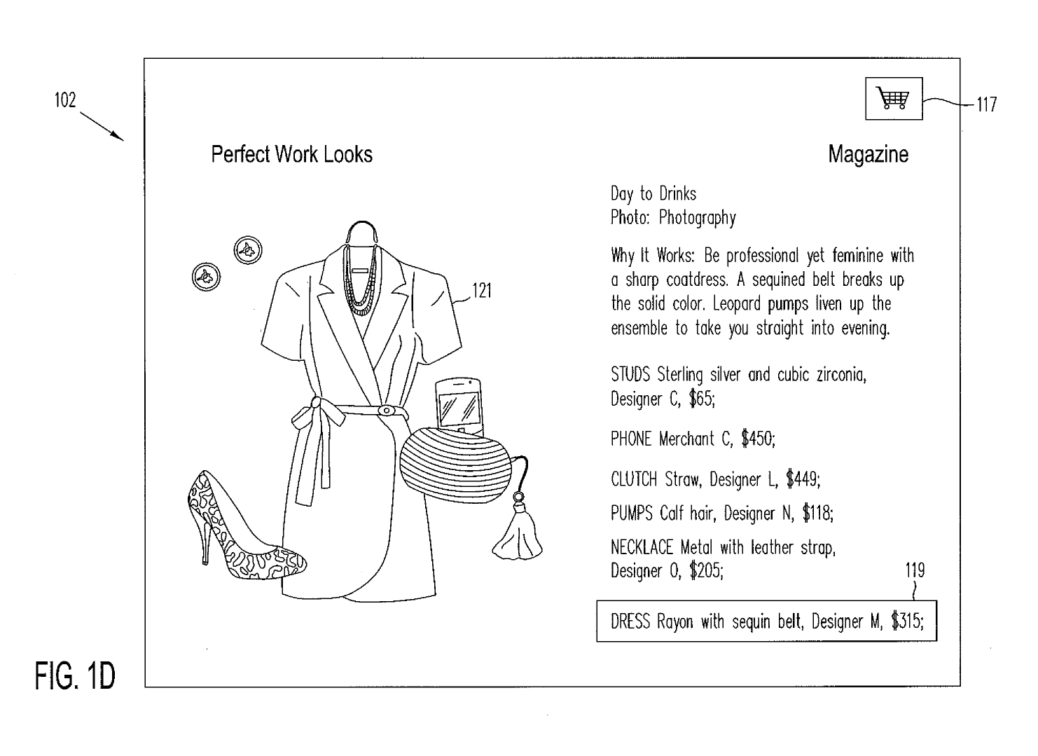

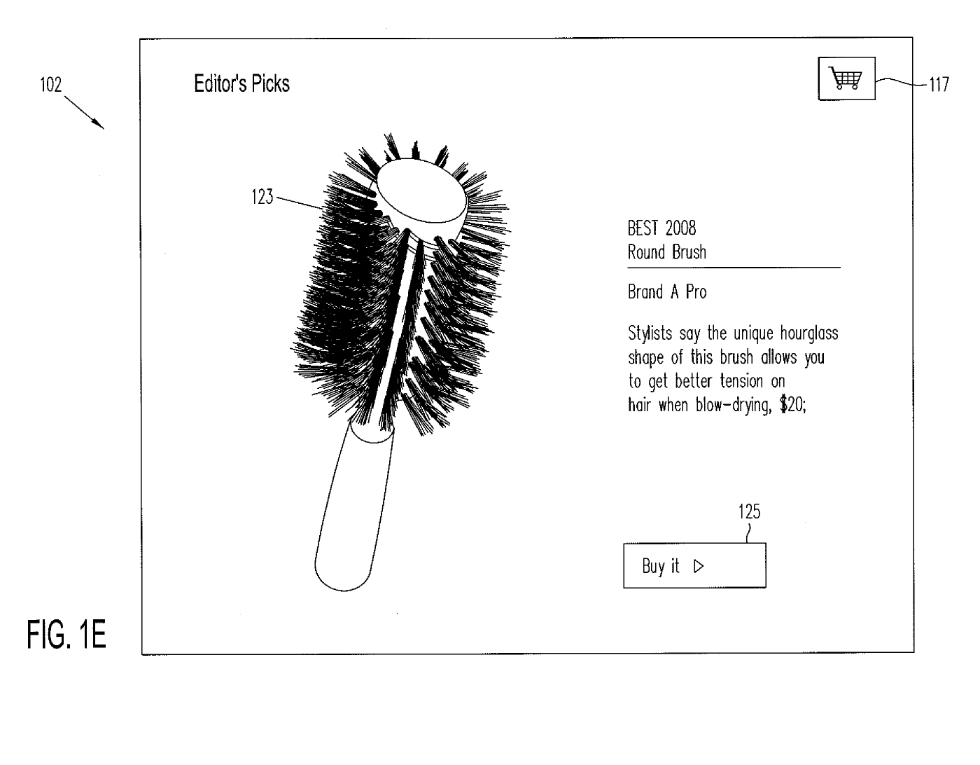

Referring to FIG. 1A, an example of digital content corresponding to a page of a publication is illustrated on a user device according to an embodiment of the present disclosure. In this example, a user or reader downloads a copy of a new issue of a favorite Magazine, e.g., InStyle® magazine, onto a user device 102 such as a mobile device, a cellular telephone, a tablet, a computer, or any other computing/communication device. The download may be from the publisher of the magazine, such as through an App, a link, or any other appropriate means.

The user may not have time to get to a store, but may have plenty of time to shop electronically for favorite styles. While reading, or generally accessing, the publication, the user may select items he or she wants to buy, for example by selecting an interface such as a link, a button, or any other active feature on the page. This selection may be made by a tap, a click, a roll-over, or any other suitable means.

Each interface may be associated with corresponding items shown on the page. For example, interfaces may be associated with separate items forming an outfit 105 that includes a shirt, a cardigan sweater 103, pants, a bag, shoes and bangles from different designers or merchants. In this example, the user may simply click on an interface 104 to select the cardigan sweater 103.

Referring to FIG. 1B, a selection view on a user device is illustrated according to an embodiment of the present disclosure. The selection view illustrated in FIG. 1B may be presented on the user device 102 upon the user selecting an item he or she wants to buy as illustrated in the embodiment of FIG. 1A.

In FIG. 1B, the user may select a feature for the selected item. For example, the user may select a size for the cardigan sweater via an active interface 106, that is, the user has a choice of buying the cardigan sweater in a size Small, Medium, Large or X-Large. It should be understood that various features applicable to the selected item may also be presented such as color, quantity, etc. The user may then choose to add this item to the cart and return to the publication by selecting an icon 109 labeled “Add to Cart”. Alternatively, the user may choose to purchase the cardigan sweater now by selecting an icon 112 labeled “Purchase now”. The user may, instead, choose to return to the publication without having the item added to the cart, and close this view by selecting icon 108, which is a cancel interface. It should be noted that icons 109, 108 or 112 may be labeled by any other appropriate label.

In one or more embodiments, the selection view of FIG. 1B may be an icon with a checkout option, a pop-up window, or a page may appear on the same screen, giving the reader an option of making a payment now or placing it in a cart for future payment. In another embodiment, a separate window or page may appear. In this example, the reader fills in the fields, such as selecting the size, and places it in a cart, for example by choosing icon 109 to keep on shopping.

If not already authenticated, the reader may be asked to provide authentication information, such as a username, password, or other information. Alternatively, this authentication information may be requested later at checkout.

The reader may then continue with reading, or generally accessing, the magazine. For example, a payment window may simply disappear or redirect the reader back to the magazine content. Once back to the magazine content, the reader may see an icon or other visual indicator that tells the reader there is at least one item in the reader's cart, which the reader may select at any time to view the contents of the cart or to make the purchase.

Referring to FIG. 1C, another example of digital content corresponding to a page of a publication is illustrated on a user device according to an embodiment of the present disclosure. While continuing to read the magazine, the user may decide to purchase another item featured on the magazine, for example, gold plated studs 115. The user may select an active interface 116 associated with gold plated studs 115.

As described above, an icon with a checkout option, a pop-up window, or a page may appear on the same screen, giving the reader an option for purchasing the selected item now or placing it in a cart for future payment. In another embodiment, a separate window or page may appear. In this example the user places it in a cart and returns to the publication.

The reader may then continue with reading the magazine. While continuing to read the magazine, the reader may see another icon or other visual indicator 117 that tells the reader there is at least one item in the reader's cart, which the reader may select at any time to view the contents of the cart or to make the purchase.

Referring to FIG. 1D, yet another example of digital content corresponding to a page of a publication is illustrated on a user device according to an embodiment of the present disclosure. While continuing to read the magazine, the user may decide to purchase another item featured on the magazine, for example, a dress 121. The user may select an active interface 119 associated with dress 121.

As described above, an icon with a checkout option, a pop-up window, or a page may appear on the same screen, giving the reader an option for purchasing the selected item now or placing it in a cart for future payment. In another embodiment, a separate window or page may appear. In this example the user places it in a cart.

The reader may then continue with reading the magazine. While continuing to read the magazine, the reader may see an icon or other visual indicator 117 that tells the reader there is at least one item in the reader's cart, which the reader may select at any time to view the contents of the cart or to make the purchase.

Referring to FIG. 1E, a further example of digital content corresponding to a page of a publication is illustrated on a user device according to an embodiment of the present disclosure. While continuing to read the magazine, the user may decide to purchase another item featured on the magazine, for example, a hair brush 123 of Brand A. In this example, the user may select an active interface 125 labeled “Buy it” associated with hair brush 123.

As described above, an icon with a checkout option, a pop-up window, or a page may appear on the same screen, giving the reader an option for purchasing the selected item now or placing it in a cart for future payment. In another embodiment, a separate window or page may appear. In this example the user places it in a cart.

The reader may then continue with reading the magazine. While continuing to read the magazine, the reader may see an icon or other visual indicator 117 that tells the reader there is at least one item in the reader's cart, which the reader may select at any time to view the contents of the cart or to make the purchase.

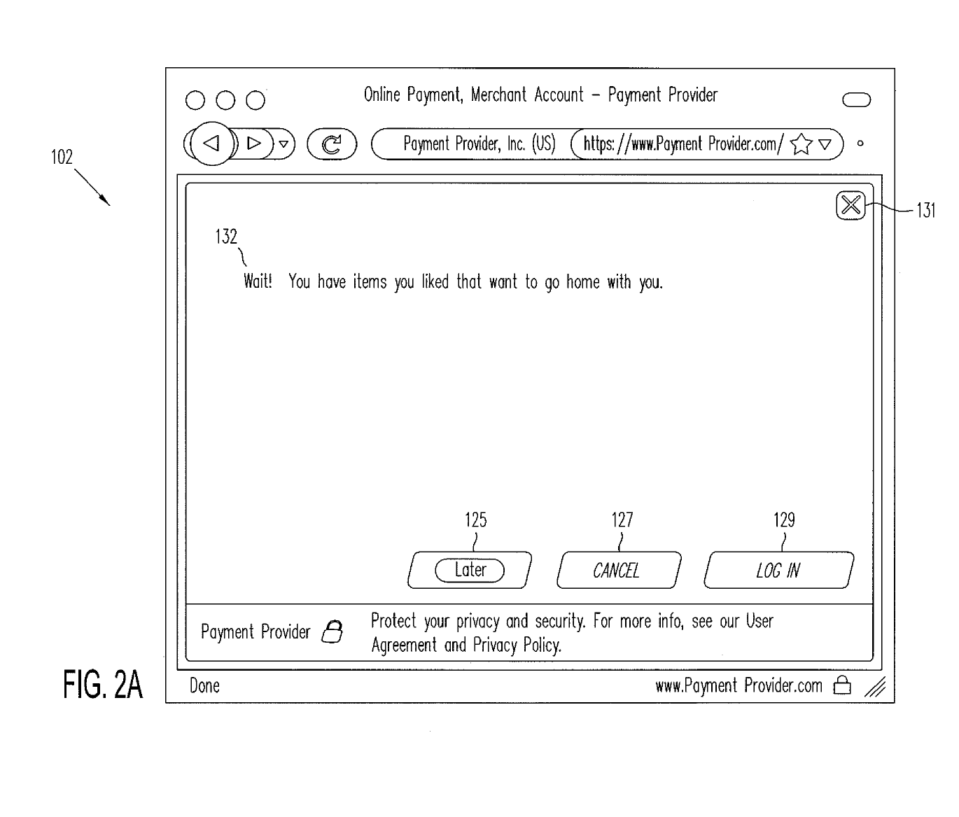

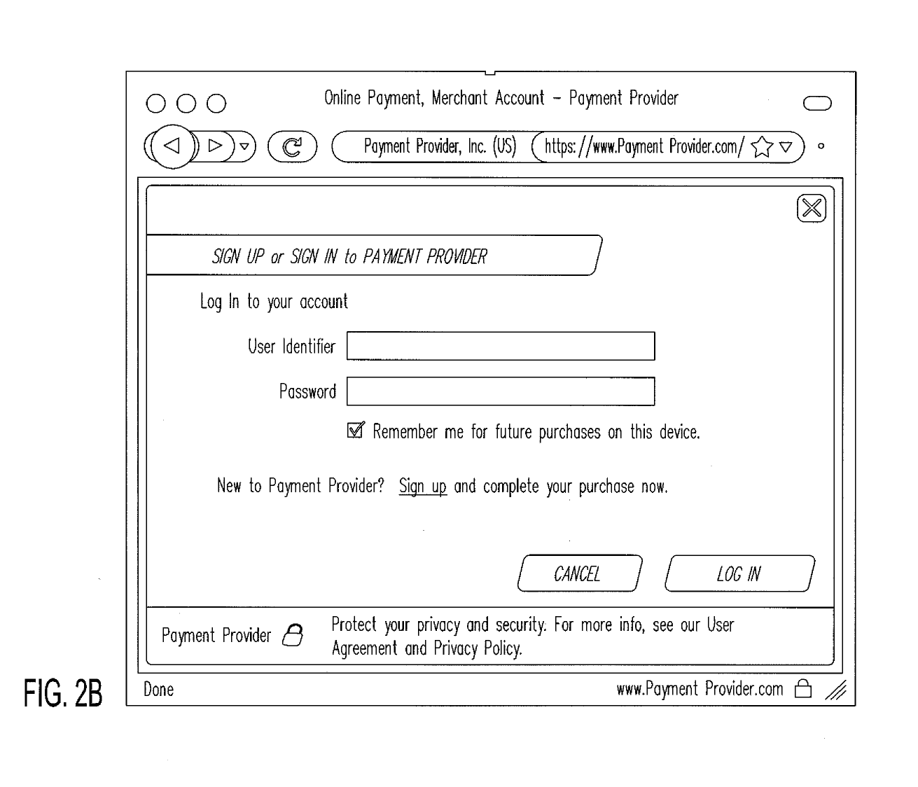

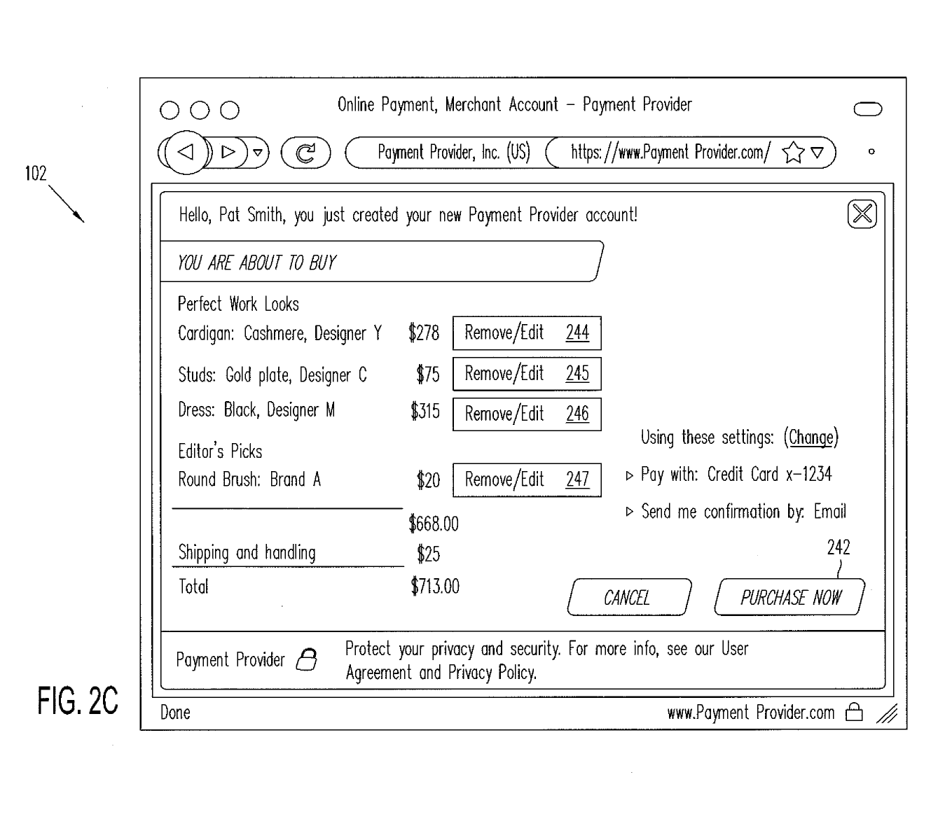

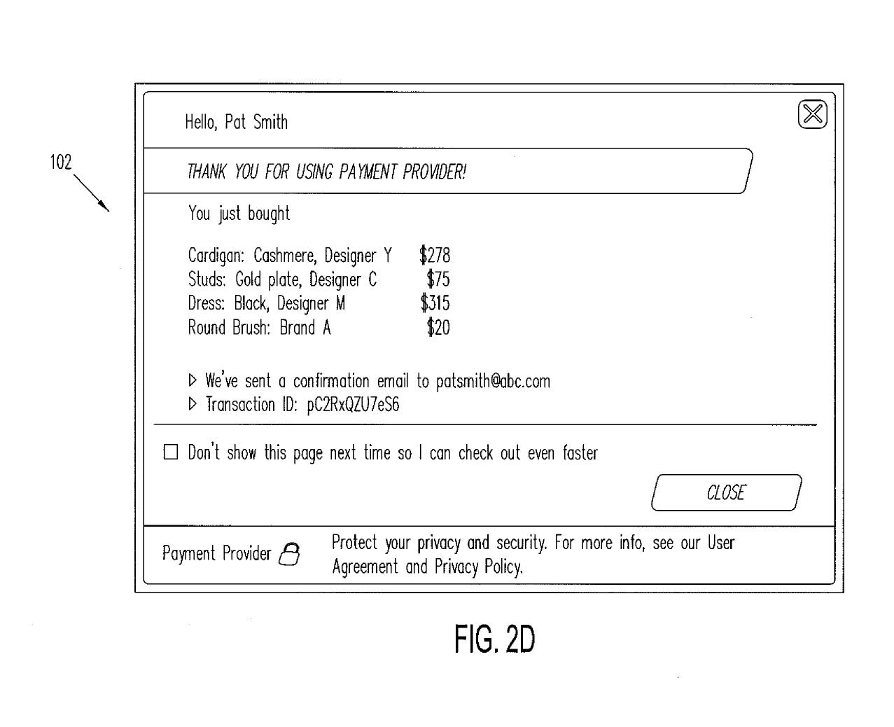

Referring now to FIG. 2A, a screen of a user device when items have been selected for purchase and the user exits out of the publication is illustrated according to an embodiment of the present disclosure. The screen of FIG. 2A may appear on user device 102 when the user exits the publication with pending items in the queue for purchase. For example, when the user is finished with the magazine, or the reader wants to exit out of the magazine, the reader may be shown the screen of the embodiment of FIG. 2A. In this embodiment, the user is presented with a message 132 that reads “Wait! You have items you liked that want to go home with you.” However, any other appropriate message may be presented to the user to indicate that there are items in a cart that are ready for purchase.

The user may be presented with options including, for example, to exit the App, to continue with the transaction at a later time, to cancel the transaction, or to log in to a payment service provider to complete the transaction. To exit the App, the user may select an interface 131. To continue with the transaction at a later time, the user may select an interface 125 labeled “Later” or any other interface having an appropriate label. To cancel the transaction, the user may select an interface 127 labeled “Cancel” or any other interface having an appropriate label. To complete the transaction, the user may select an interface 129 labeled “Log In” or any other interface having an appropriate label.

If the user selects interface 129 labeled “Log In”, a “Sign Up” or “Sign In” view as illustrated in the embodiment of FIG. 2B may be presented to the user. In this embodiment, the payment may be made through a payment provider, such as PayPal, Inc. of San Jose, Calif. The reader may be asked to enter information to process the payment, such as a user identifier (e.g., an email address, phone number, or user name) and a password or PIN. If the user does not have a payment service account, the user may sign up for an account and complete the purchase at that time.

Referring to FIG. 2C, a screen of a user device showing the contents of a cart is illustrated according to an embodiment of the present disclosure. In this example, the cart's contents include a cardigan sweater by Designer Y as selected from the content shown in the embodiment of FIG. 1A, gold plated studs by Designer C as selected from the content shown in the embodiment of FIG. 1C, a black dress by Designer M as selected from the content shown in the embodiment of FIG. 1D, and a round brush by Brand A Pro as selected from the content shown in the embodiment of FIG. 1E. Once presented with the cart contents as in the embodiment of FIG. 2C, the reader may review the contents of the cart and edit as needed. To edit the cart contents, the reader may select one or more interfaces 244-247 labeled “Remove/Edit”, or any other appropriate label. For example, the reader may decide to not purchase the cardigan sweater, to add another pair of earrings, to change the size of the dress, etc. Once ready for checkout, the reader may select an interface 242 labeled “Purchase now” to proceed with the transaction.

FIG. 2D illustrates a screen showing confirmation of the transaction according to an embodiment of the present disclosure. A payment service provider may process the payment request and inform the reader whether the payment has been made. In this example, the reader is presented with a list of items bought and confirmation of the transaction.

By using the payment service provider, the user's information and funds may be safely sent to the Magazine or publisher using the publisher platform associated with the payment service provider. The publisher may then notify and pay the various vendors about the transactions, and the items may be delivered to the user without the user having to go into the different stores or retailers from which the items were just purchased.

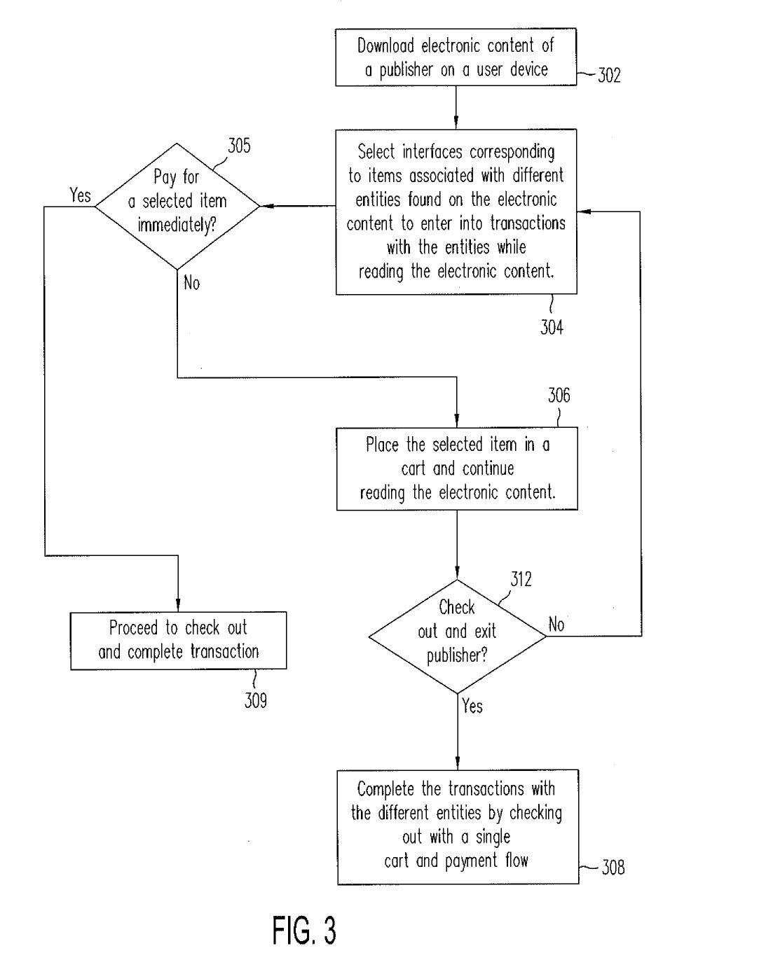

Referring now to FIG. 3, a flow diagram illustrates a method for conducting a transaction through a publisher according to an embodiment of the present disclosure.

In block 302, a user or reader may download digital content (also referred to as electronic content in this embodiment), for example, the user may download a magazine or any other publication on a user device such as a mobile device, a cellular telephone, a tablet, a computer, or any other computing or communication device.

In block 304, digital content may contain pages having one or more interfaces such as links associated with items from various entities, for example, links associated with advertisements for products or services from various business entities. The user may select desired interfaces found on one or more pages of the digital content to conduct transactions with the entities while reading, or generally accessing, the digital content.

In block 305, a user may select to pay for one or more selected items immediately. In that case, in block 309, the user may proceed to check out and complete the transaction at that time. The user may then choose to go back to reading the digital content. Alternatively, in block 306, the user may decide to place the selected items in a cart and continue reading the digital content until the user decides to check out and exit the publication (block 312). Advantageously, the different items from different entities may be placed in a single cart. In block 308, once the user decides to check out or exit the publication, the transactions may be completed with a single cart and payment flow even if the selected items are from different entities.

In one example, while continuing to read the magazine, the user may read about a fundraiser in Malibu that benefits children from Haiti. If the user wishes to make a donation, the user may select a link, donation button, or other active feature on the page. This selection presents the reader with a screen to make the donation immediately, or place it in a cart for later payment. For example, an icon with a checkout option, a pop-up window, or a page may appear on the same screen, giving the reader an option of making a donation now or placing it in a cart for future payment. In another embodiment, a separate window or page may appear. In this example, the reader fills in the fields, such as donation amount, and places it in a cart.

The reader may then continue with reading the magazine. For example, the payment window may simply disappear or redirect the reader back to the magazine content. Once back to the magazine content, the reader may see an icon or other visual indicator that tells the reader there is at least one item in the reader's cart, which the reader may select at any time to make the purchase.

The reader continues with the magazine and reads a profile on a designer. The reader is interested in possibly purchasing items from the designer, so the reader selects a link within the article, similar to the embodiments described above. The reader is shown a page where the user may select items for purchase, including selection of sizes and colors of different items from the designer. The reader decides to purchase a pair of jeans and a shirt and adds those to the cart. The cart is updated with the newly added items and may also be updated with a new dollar amount.

Next, the user decides to continue with reading or accessing the magazine and comes across an advertisement for a line of cosmetics. The reader accesses a link from the advertisement and is presented with a page on which the reader may select available cosmetic products for purchase. The reader selects two different types of lipstick and a skin cream. These items are added to the reader's cart and the user decides to continue with reading the magazine.

After a few more pages, the reader comes across an interesting review of a book. Within the review, active links include the author's name, the name of the book, another book by the same author, and two books by different authors that are reference for comparison. The reader may select any of the links to be taken to different pages with information to purchase books written by the author, the book under review, the other book by the author, and the two different books, respectively. In this example, the reader selects the book under review and one other book by the author. These are placed in the reader's cart and the total amount updated if applicable.

The reader decides to continue with the magazine. The reader finishes the magazine, with no more purchases. The reader may access the cart on screen to review the contents of the cart. The cart may be accessed any time, as a checkout/shopping cart icon appears on every page of the magazine once a first item is put into the cart.

In one embodiment, the payment is made to the publisher, who then distributes payment to the various vendors of the purchased items. After receipt of payment, the individual vendors or sellers ship the purchased items to the reader. In another embodiment, the payment provider sends funds directly to the individual vendors or sellers, such as through PayPal's Adaptive Payments. The sellers, upon confirmation of payment, may then ship the purchased items to the reader. Costs, such as shipping and handling, may be separated and allocated as applicable.

In one embodiment, all items or donations available for purchase from the published content are selected through a platform hosted by the publisher. In other words, the cart is managed by the publisher. This allows a single platform selection and checkout from different sellers. The platform may be provided to the publisher by a service provider or a payment provider, such as PayPal®.

As a result, the reader of a magazine or other publication may purchase different items from different sellers and make donations or other payments from the publication without having to individually make payments to each different seller or payee. The reader is able to place desired items into a single cart and go through a single payment flow to make the payment.

Advertisers selling items directly to readers (through the publisher) may tell which publications are driving the most sales. They may use these figures as market research for future offerings in addition to the profits from the sales. The publisher may be able to get a percentage of sales from the advertisers. The payment provider may get the merchant fee and transaction fees for all the purchases/payments made through the publisher's platform. The readers get an accessible point of sale that is easy to use and is provided by a safe and secure payment service.

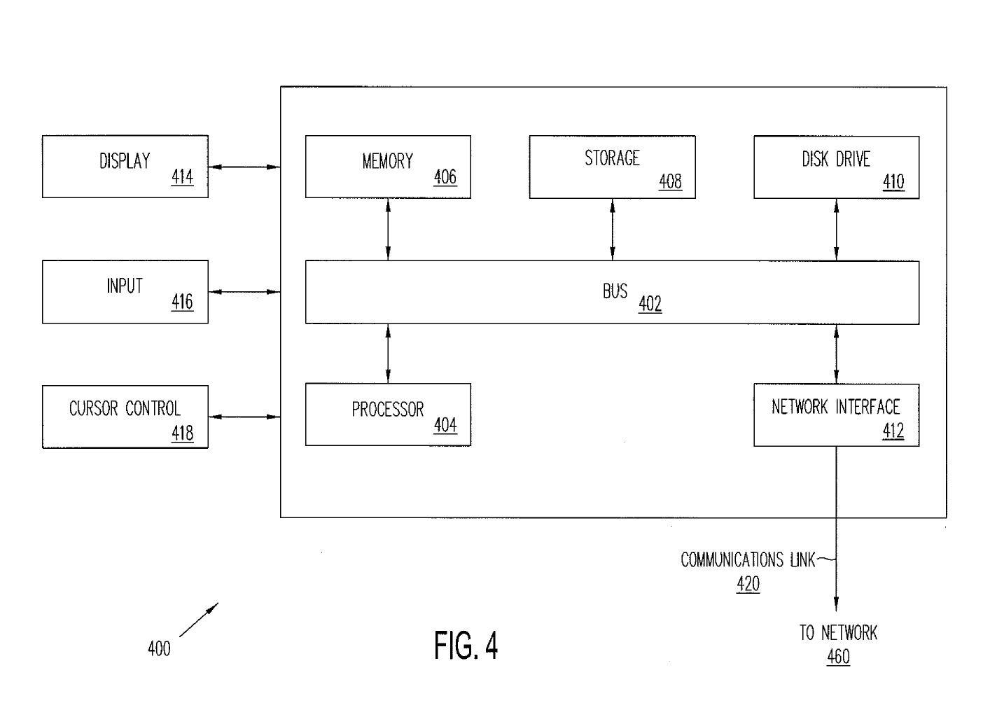

FIG. 4 is a block diagram of a computer system 400 suitable for implementing various devices described herein. In various implementations, a user device may comprise a network communication device (e.g., mobile cellular phone, laptop, personal computer, tablet, etc.) capable of communicating with a network, and a service provider device (such as managed by PayPal® or eBay®) may comprise a network computing device (e.g., a network server). In other implementations, it should be appreciated that a payment provider device or publisher device, such as for receiving, processing, and/or communicating information, may comprise a network communication device (e.g., mobile cellular phone, laptop, personal computer, server, etc.) capable of communicating with the network, without departing from the scope of the present disclosure. Accordingly, it should be appreciated that each of the devices may be implemented as the computer system 400 for communication with the network in a manner as follows.

In accordance with various embodiments of the present disclosure, computer system 400, such as a mobile communication device and/or a network server, includes a bus 402 or other communication mechanism for communicating information, which interconnects subsystems and components, such as processing component 404 (e.g., processor, micro-controller, digital signal processor (DSP), etc.), system memory component 406 (e.g., RAM), static storage component 408 (e.g., ROM), disk drive component 410 (e.g., magnetic or optical), network interface component 412 (e.g., modem or Ethernet card), display component 414 (e.g., CRT, LCD, touch screen, LED, etc.), input component 416 (e.g., keyboard or virtual keypad), and optional cursor control component 418 (e.g., mouse or trackball). In one implementation, disk drive component 410 may comprise a database having one or more disk drive components.

In accordance with embodiments of the present disclosure, computer system 400 performs specific operations by processor 404 executing one or more sequences of one or more instructions contained in system memory component 406. Such instructions may be read into system memory component 406 from another computer readable medium, such as static storage component 408 or disk drive component 410. In other embodiments, hard-wired circuitry may be used in place of or in combination with software instructions to implement the present disclosure.

Logic may be encoded in a computer readable medium, which may refer to any medium that participates in providing instructions to processor 404 for execution. Such a medium may take many forms, including but not limited to, non-volatile media and volatile media. In one embodiment, the computer readable medium is non-transitory. In various implementations, non-volatile media includes optical or magnetic disks, such as disk drive component 410, and volatile media includes dynamic memory, such as system memory component 406. In one aspect, data and information related to execution instructions may be transmitted to computer system 400 via a transmission media, such as in the form of acoustic or light waves, including those generated during radio wave and infrared data communications. In various implementations, transmission media may include coaxial cables, copper wire, and fiber optics, including wires that comprise bus 402.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 430 (e.g., a network 460, such as a LAN, WLAN, PTSN, and/or various other wired or wireless networks, including telecommunications, mobile, and cellular phone networks) may perform instruction sequences to practice the present disclosure in coordination with one another.

Computer system 400 may transmit and receive messages, data, information and instructions, including one or more programs (i.e., application code) through communication link 430 and communication interface 412. Received program code may be executed by processor 404 as received and/or stored in disk drive component 410 or some other non-volatile storage component for execution.

According to one or more embodiments herein, a publication such as a magazine may be downloaded onto a user's device, such as a smart phone, PC, or tablet, so that the user may read the publication electronically. Certain pages of the publication may contain links to purchase items or services or to donate money. By selecting on desired links, the reader may make purchases or donate money while reading the publication. Selected items or donations may be placed in a cart within the publisher's platform, where the reader may pay for items in the cart at any time, such as through a payment provider like PayPal, Inc. As a result, a reader browsing a magazine or other publication is able to make purchases from different sites or merchants with a single cart and payment process.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein showings therein are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

1. A method comprising:
linking one or more entities with a publisher platform hosted by an electronic publication, wherein a reader downloads the electronic publication on a user device, and the one or more entities advertise one or more items on the electronic publication;
receiving, from the reader, a request to purchase selected one or more items as advertised by the one or more entities while accessing the electronic publication;
placing the selected one or more items in the publisher platform of the electronic publication that links the one or more entities; and
processing the request to purchase with a single checkout flow.

2. The method of claim 1, wherein the receiving the request to purchase the selected one or more items further comprises receiving the request via a corresponding active interface on a page of the electronic publication.

3. The method of claim 2, wherein the receiving the request to purchase the selected one or more items further comprises receiving the request via the corresponding active interface by a tap, a click, or a roll-over.

4. The method of claim 1, wherein the selected items further comprise a product, a service, digital content, a subscription, or making a charitable contribution or donation.

5. The method of claim 1, further comprising giving the reader an option to pay for the selected one or more items now or placing the selected one or more items in a cart for future payment.

6. The method of claim 5, further comprising:
if the reader opts to place the selected one or more items in the cart for future payment, redirecting the reader to continue accessing the electronic publication and placing a visual indicator on one or more pages of the electronic publication that tells the reader there is one or more items in the cart, which the reader selects at any time to view and/or make payment.

7. The method of claim 1, wherein the processing the request to purchase further comprises:
giving the reader an option to pay for the selected one or more items once the reader is finished with the electronic publication or is otherwise ready to checkout the selected items; and
directing the reader to go to a cart on the publisher platform and pay for all the selected items at once.

8. The method of claim 1, wherein the processing the request to purchase further comprises processing the request to purchase through a payment service provider.

9. A system comprising:
a payment provider server that interacts with a user device associated with a user and one or more servers associated with one or more entities over a network; and
one or more memories adapted to store a plurality of machine-readable instructions which when executed by one or more processors are adapted to cause the system to:
receive, from the user, a request to purchase one or more selected items, which the user selects by selecting interfaces associated with the items while accessing digital content of a publisher downloaded onto the user device, wherein the items are offered by the one or more entities on one or more pages of the digital content;
place the selected items in a cart within a platform maintained by the publisher; and
process the request to purchase the selected items in the cart at any time with a single cart and payment flow.

10. The system of claim 9, wherein the plurality of machine-readable instructions which when executed by the one or more processors are further adapted to cause the system to receive the request to purchase via a tap, a click, or a roll-over on the interfaces associated with the items.

11. The system of claim 9, wherein the plurality of machine-readable instructions which when executed by the one or more processors are further adapted to cause the system to give the user an option to pay for the selected items immediately or to place the selected items in the cart for future payment.

12. The system of claim 11, wherein the plurality of machine-readable instructions which when executed by the one or more processors are further adapted to cause the system to:
if the user opts to place the selected items in the cart for future payment, redirect the user to continue accessing the digital content and place a visual indicator on one or more pages of the digital content that tells the user there is one or more selected items in the cart, which the reader selects at any time to view and/or make payment.

13. The system of claim 9, wherein the plurality of machine-readable instructions which when executed by the one or more processors are further adapted to cause the system to process the request to purchase the selected items through a payment service provider.

14. A non-transitory computer-readable medium having computer executable instructions for performing a method comprising:
linking one or more entities with a platform hosted by a publisher of digital content;
receiving a request for a transaction by a user accessing the digital content, wherein the request comprises the user selecting one or more desired items from the one or more entities while accessing the digital content;
placing the one or more desired items in a single cart within the platform; and
processing the request for the transaction at any time with the single cart on the platform and a single payment flow.

15. The medium of claim 14, wherein the computer executable instructions further comprise receiving the request for the transaction via one or more interfaces associated with one or more items offered by the one or more entities while the user reads the digital content, wherein the digital content of the publisher is downloaded by the user on a user device.

16. The medium of claim 15, wherein the computer executable instructions further comprise receiving the request for the transaction from the user via the user selecting the one or more interfaces associated with the items by a tap, a click, or a roll-over.

17. The medium of claim 14, wherein the one or more desired items further comprise a product, a service, digital content, a subscription, or making a charitable contribution or donation.

18. The medium of claim 14, wherein the computer executable instructions further comprise giving the user an option to pay for the one or more desired items now or placing the one or more desired items in the cart for future payment.

19. The medium of claim 18, wherein the computer executable instructions further comprise:
if the user opts to place the one or more desired items in the cart for future payment, redirecting the user to continue accessing the digital content and placing a visual indicator on one or more pages of the digital content that tells the user there is one or more items in the cart, which the user selects at any time to view and/or make payment.

20. The medium of claim 14, wherein the computer executable instructions further comprise processing the request for the transaction for the one or more desired items once the user is finished with the digital content or is otherwise ready to checkout; wherein the user is given an option to go to the cart on the platform and pay for all the selected items at once.
